(19) United States
(12) Patent Application Publication
(10) Pub. No.: US 2025/0213031 A1
(43) Pub. Date: Jul. 3, 2025

(54) TOOTHBRUSH AND CONTROL METHOD THEREOF

(71) Applicant: GUANGZHOU STARS PULSE CO.,LTD., GUANGZHOU (CN)

(72) Inventor: YUWEI ZHANG, GUANGZHOU (CN)

(21) Appl. No.: 18/934,696

(22) Filed: Nov. 1, 2024

Related U.S. Application Data
(63) Continuation of application No. PCT/CN2024/107868, filed on Jul. 26, 2024.

(30) Foreign Application Priority Data
Dec. 29, 2023 (CN) 202311872360.6

(51) Int. Cl. A46B 15/00; A46B 13/02; A61C 17/22; A61C 17/34

(52) U.S. Cl. CPC A46B 15/0006; A46B 13/023; A61C 17/221; A61C 17/34

(57) ABSTRACT

A control method of a toothbrush, a control device of the toothbrush, the toothbrush and a computer-readable storage medium are provided. The toothbrush includes a brush head and a handle. A motor is disposed in the handle. The motor includes a rotor. The control method includes obtaining oral health data and/or real-time brushing data; determining a target motion range corresponding to the rotor of the motor according to the oral health data and/or the real-time brushing data; and controlling the rotor to reciprocate in a circumferential direction within the target motion range to drive the brush head to brush teeth.

### TECHNICAL FIELD

The present disclosure relates to a technical field of oral cleaning, and in particular to a toothbrush and control method thereof.

### BACKGROUND

Electric toothbrushes are more and more popular due to their good cleaning effect. Electric toothbrushes generally comprise a brush head and a handle. The handle is commonly equipped with a motor therein. The brush head is controlled to brush teeth by controlling the motor to move, thereby realizing a function of electric brushing.

Currently, when a user uses a conventional electric toothbrush to brush the teeth, the conventional electric toothbrush is prone to hitting the teeth, which seriously affects oral health and user experience of the user.

### SUMMARY

The present disclosure provides a control method of a toothbrush and the toothbrush.

In one aspect, the present disclosure provides the control method of the toothbrush. The toothbrush comprises a brush head, a motor, and a handle. The motor is disposed in the handle. The motor comprises a rotor. The control method comprises steps:
obtaining oral health data and/or real-time brushing data:
determining a target motion range corresponding to the rotor of the motor of the toothbrush according to the oral health data and/or the real-time brushing data; and controlling the rotor to reciprocate in a circumferential direction within the target motion range to drive the brush head of the toothbrush to brush teeth.

In a second aspect, the present disclosure provides the toothbrush. The toothbrush comprises a memory and a processor. Computer programs are stored in the memory. When the computer programs are executed by the processor, the processor is configured to implement the control method described above.

Details of one or more embodiments of the present disclosure are set forth in following drawings and description. Other features and characteristics of the present disclosure are made apparent from the specification, the drawings, and claims.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1A is a schematic diagram showing an application scenario of a control method of a toothbrush according to one embodiment of the present disclosure.

FIG. 1B is a structural schematic diagram of a motor according to one embodiment of the present disclosure.

FIG. 2 is a flow chart of the control method of the toothbrush according to one embodiment of the present disclosure.

FIG. 3A is a schematic diagram of a target motion range of a rotor of the motor according to one embodiment of the present disclosure.

FIG. 3B is a schematic diagram of a reciprocating swing range of the rotor with a reference position as a reference zero axis according to one embodiment of the present disclosure.

FIG. 3C is a schematic diagram of a possible reference position of the rotor according to one embodiment of the present disclosure.

FIG. 4 is a flow chart of determining the target motion range corresponding to the rotor of the motor according to oral health data.

FIG. 5 is a flow chart of determining the target motion range corresponding to the rotor of the motor according to real-time brushing data.

FIG. 6 is a schematic diagram of tooth surfaces according to one embodiment of the present disclosure.

FIG. 7 is a flow chart of determining the target motion range corresponding to the rotor of the motor according to the oral health data and the real-time brushing data.

FIG. 8 is a flow chart of the control method of the toothbrush according to another embodiment of the present disclosure.

FIG. 9 is a flow chart of the control method of the toothbrush according to another embodiment of the present disclosure.

FIG. 10 is a block diagram of a control device of the toothbrush according to one embodiment of the present disclosure.

FIG. 11 is a block diagram of the toothbrush according to one embodiment of the present disclosure.

### DETAILED DESCRIPTION

Technical solutions in the embodiments of the present disclosure will be clearly and completely described below in conjunction with the accompanying drawings in the embodiments of the present disclosure. Obviously, the described embodiments are only a part of the embodiments of the present disclosure, rather than all of the embodiments. Based on the embodiments of the present disclosure, all other embodiments obtained by those of ordinary skill in the art without creative work shall fall within the protection scope of the present disclosure.

In a conventional electric toothbrush, a physical limiting method is adopted to limit a rotation range of a rotor in a motor thereof. Commonly, a limiting structure is disposed in the motor to limit the rotation range of the rotor disposed in the motor. Since an actual maximum rotation angle of a brush plate of a brush head thereof is determined by the limiting structure in the motor and a position of the limiting structure is fixed, the maximum rotation angle of the brush head is commonly fixed, which affects a cleaning effect of the conventional toothbrush.

Currently, in order to improve a cleaning effect of a conventional electric toothbrush, an electric limiting method is adopted to limit a rotation range of a rotor in a motor of the conventional electric toothbrush, so that a maximum rotation angle of a brush head thereof is adjustable. However, a brush head of the conventional electric toothbrush adopting the electric limiting method has a large rotation angle during use, making the brush head easy to hit or scrape teeth, which seriously affects oral health and user experience of a user.

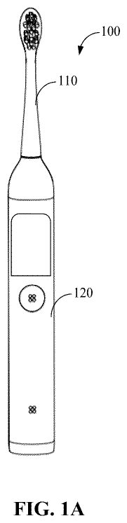

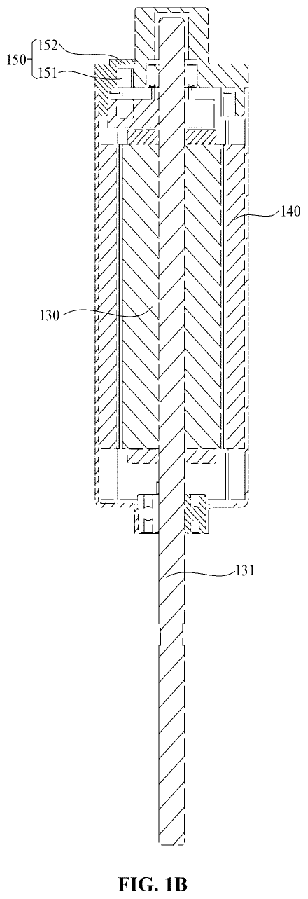

FIG. 1A is a schematic diagram showing an application scenario of a control method of a toothbrush according to one embodiment of the present disclosure. As shown in FIG. 1A, the control method of embodiments of the present disclosure is applied in the toothbrush 100. The toothbrush 100 comprises a brush head 110 and a handle 120. The brush head 110 and the handle 120 are detachably connected.

As shown in FIG. 1B, a motor 20 is disposed in the handle 120. When the toothbrush 100 is in a working state, the motor 20 is in a running state and drives the brush head 110 to move to clean an oral cavity. In the embodiment of the present disclosure, the toothbrush 100 is able to obtain oral health data and/or real-time brushing data, and determine a target motion range corresponding to the rotor of the motor 20 according to the oral health data and/or the real-time brushing data. The toothbrush 100 further controls the rotor to reciprocate in a circumferential direction within the target motion range to drive the brush head 110 to brush the teeth.

FIG. 1B is a structural schematic diagram of the motor according to one embodiment of the present disclosure. As shown in FIG. 1B, the motor 20 comprises a rotor 130, a stator module 140, and a control module 150. The rotor 130 comprises a central shaft 131. The central shaft 131 is detachably connected to the brush head 110. The stator module 140 is able to cooperate with the rotor 130 magnetically to drive the rotor 130 to rotate. The stator module 140 may be a permanent magnet or an electromagnet. In the embodiments of the present disclosure, the motor 20 does not comprise a physical limit structure, but adopts an electric limit method. The motor 20 is able to flexibly control and adjust a motion range of the rotor 130 by a software, so that a maximum rotation angle of the brush head 110 is adjustable, which effectively prevent the teeth from being hit during use of the toothbrush 100, makes a cleaning range of the toothbrush 100 more comprehensive, and improve a cleaning effect of the toothbrush 100.

The control module 150 is configured to control the rotor 130 to reciprocate in the circumferential direction according to the target motion range. In some embodiments, the control module 150 is configured to control the rotor 130 to reciprocate with a reference position as a reference zero axis according to the target motion range, and is configured to control the rotor 130 to rotate to change the reference position to increase a swing amplitude of the rotor 130 in the circumferential direction. Furthermore, the control module 150 is configured to control the central shaft 131 to reciprocatingly swing with the reference position as the reference zero axis according to the target motion range, and is configured to control the central shaft 131 to rotate to change the reference position. During movement of the central shaft 131, the central shaft 131 drives the brush head 110 to move to realize oral care.

The control module 150 comprises a position sensor 151 and a controller 152. The position sensor 151 is configured to detect a current position of the rotor 130. The controller 152 is configured to determine whether the current position of the rotor 130 is within a position limit range corresponding to the target motion range. If the current position of the rotor 130 is not within the position limit range, the rotor 130 is controlled to reset to be within the position limit range. The position sensor 151 may comprises, but is not limited to, a Hall sensor, an optical sensor, or an element with a position detection function.

Furthermore, the position sensor 151 is configured to detect a rotation angle and a swing angle of the rotor 130. The controller 152 is configured to accurately control the rotor 130 to reciprocate in the circumferential direction according to the rotation angle and the swing angle of the rotor 130 fed back by the position sensor 151.

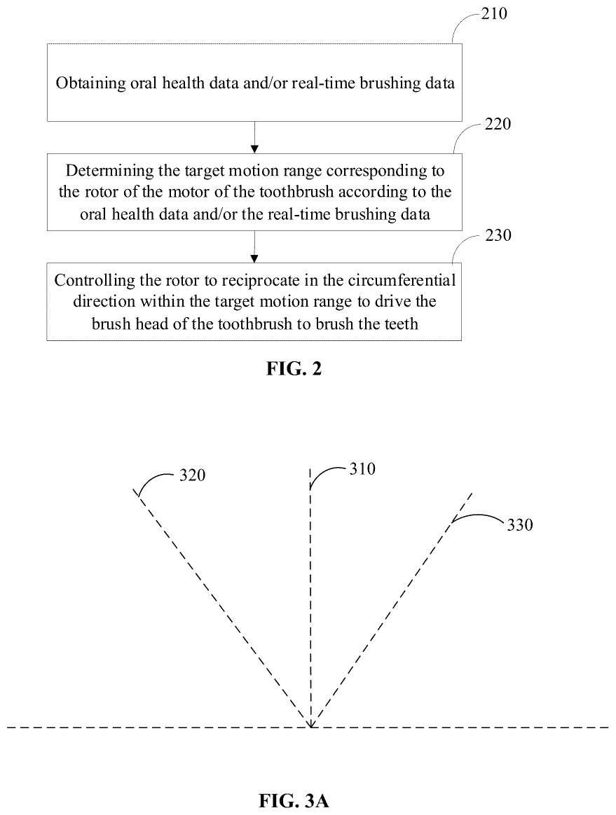

As shown in FIG. 2, in one embodiment, the present disclosure provides a control method of the toothbrush 100. The control method is applied to the toothbrush 100 and comprises steps 210-230.

The step 210 comprises obtaining oral health data and/or real-time brushing data.

The oral health data refers to data for characterizing a health condition of the oral cavity of the user. Optionally, the oral health data comprises one or more of a gum health level, dental caries information, dental plaque residue, and oral disease information.

The gum health level refers to a health degree of gums of the user. The gum health level may comprises a plurality of levels, such as “very healthy”, “generally healthy”, “normal healthy”, “unhealthy”, etc., but not limited thereto. Optionally, the gum health level is determined based on a color of the gums of the user, whether the gums bleed, etc. For example, if the gums are pink and are not bleeding, the gum health level is determined to be “very healthy”. If the gums are light red and are not bleeding, the gum health level is determined to be “generally healthy”. If the gums are red but are not bleeding, the gum health level is determined to be “normal healthy”. If the gums are dark red and are bleeding, the gum health level is determined to be “unhealthy”. However, judgement conditions are not limited thereto. The judgement conditions of the gum health level of the user may be determined by combining with more detailed gum information.

Dental caries information indicates whether the user has dental caries in his or her mouth. For example, the dental caries information may comprise but is not limited to information such as the number of dental caries in the mouth and a location of the dental caries. The more dental caries in the mouth, the more unhealthy the mouth is.

The dental plaque residue refers to an amount of dental plaque residue in the mouth. The more dental plaque residue there is, the less healthy the oral cavity is.

The oral disease information indicates whether the user has oral disease. For example, the oral disease information may comprise, but is not limited to a name of the oral disease (such as oral ulcers, periodontitis, etc.), a location of a disease site in the oral cavity of the user, etc.

In some embodiments, the toothbrush 100 obtains the oral health data of the user before brushing the teeth. Optionally, the user may enter and update the oral health data on a terminal device according to an actual oral health situation. Before brushing the teeth, the toothbrush 100 establishes a communication connection (such as a BLUETOOTH connection, etc.) with the terminal device. The terminal device may send latest oral health data of the user to the toothbrush 100. Optionally, before brushing the teeth, the toothbrush 100 may collect the oral information of the user through a sensor thereof, and obtain the oral health data of the user by analyzing oral information. For example, a camera is disposed on the brush head of the toothbrush 100. Before brushing the teeth, the user may place the brush head of the toothbrush 100 into the mouth. The toothbrush 100 collects oral images of the user through the camera, and then the toothbrush 100 may analyze the oral images to obtain the oral health data of the user.

The real-time brushing data refers to brushing data obtained in real time by the toothbrush 100 during a brushing operation. Optionally, the real-time brushing data comprises one or more of a real-time brushing position of the brush head, a real-time brushing pressure, a real-time brushing mode, and a real-time motion state, when the toothbrush is in the working state.

The working state refers to a state where the toothbrush 100 controls the motor 20 to run and performs the brushing operation. When the toothbrush 100 is in the working state, the real-time brushing position of the brush head refers to a real-time position of the brush head in the oral cavity. The real-time brushing position is a specific position of the brush head in the oral cavity, such as a position of the teeth corresponding to the brush head in the oral cavity or tooth surfaces of the teeth corresponding to the brush head of the brush head. The tooth surfaces corresponding to the brush head are determined according to the real-time brushing position of the brush head. Of course, a specific oral area and/or a specific tooth area corresponding to the brush head may also be determined according to the real-time brushing position of the brush head.

The real-time brushing pressure refers to a real-time pressure felt by the brush head in the oral cavity when the toothbrush 100 is in the working state. By collecting the real-time brushing pressure during a brushing process, the toothbrush 100 detects whether overpressure occurs during the brushing process, whether bristles of the brush head leave the tooth surfaces, etc.

The real-time brushing mode refers to one of brushing modes selected by the toothbrush 100 when the toothbrush 100 is in the working state. The toothbrush 100 has different brushing modes. For example, the toothbrush 100 has a whitening mode, a cleaning mode, a soothing mode, a strong mode, etc. Different brushing modes correspond to different motor operating parameters, so as to realize different oral cleaning effects and care effects. The motor operating parameters comprise, but are not limited to swing parameters and/or rotation parameters of the rotor 130, running time, and other parameters. The swing parameters refer to parameters that the motor 20 controls the rotor 130 to reciprocatingly swing with the reference position as the reference zero axis. The rotation parameters refer to parameters that the motor 20 controls the rotor 130 to rotate to change the reference position. The user is able to select any one of the brushing modes according to actual needs, or the toothbrush 100 is allowed to select the real-time brushing mode according to an oral condition of the user. When the toothbrush 100 enters the working state, the toothbrush 100 runs the real-time brushing mode and controls the motor 20 to run according to the motor operating parameters corresponding to the real-time brushing mode to drive the brush head to brush the teeth.

The real-time motion state refers to a real-time movement status of the toothbrush 100 in the working state. The real-time motion state comprises information such as a real-time motion speed and a motion direction of the toothbrush 100. The toothbrush 100 is able to detect whether the brush head shifts between different oral areas by collecting the real-time motion state of the toothbrush 100 during the brushing process, and is able to assist in determining the real-time brushing position of the brush head according to the real-time motion state.

In some embodiments, the toothbrush 100 further comprises a detection device. The detection device comprises one or more of a posture sensor, the camera, a motion sensor, a pressure sensor, a photoelectric sensor, etc. When the toothbrush 100 is in the working state, the real-time brushing data is obtained through the detection device. For example, during the brushing operation of the toothbrush 100, the oral images of the oral cavity are collected by the camera, and the toothbrush 100 identifies and analyzes the oral images to determine the real-time brushing position of the brush head. Alternatively, during the brushing operation of the toothbrush 100, the real-time brushing pressure is obtained by the pressure sensor. Alternatively, during the brushing operation of the toothbrush 100, motion information of the toothbrush 100 is collected by the posture sensor and the motion sensor (such as an acceleration sensor, a speed sensor, etc.) to determine the real-time motion state of the toothbrush 100. Alternatively, during the brushing operation of the toothbrush 100, a coverage of the tooth surfaces by the bristles of the brush head is detected by the photoelectric sensor, thereby assisting in determining the tooth surfaces where the brush head is located. Further, the photoelectric sensor helps to generate brushing data corresponding to a current brushing process (such as a tooth surface coverage, a cleaning rate, etc.) after the current brushing process is completed. The detection device is able to accurately obtain the real-time brushing data of the toothbrush 100 during the brushing process, so that the target motion range corresponding to the rotor 130 of the motor 20 is accurately determined, which further reduces a possibility of the toothbrush 100 hitting the teeth during the brushing process.

The step 220 comprises determining the target motion range corresponding to the rotor of the motor of the toothbrush according to the oral health data and/or the real-time brushing data.

In some embodiments, the toothbrush 100 determines the target motion range corresponding to the rotor 130 of the motor 20 according to the oral health data. When the oral health data indicates that the oral cavity of the user is relatively healthy, it means that the oral cavity of the user is less sensitive. Even when the rotation angle of the brush head is large, the brush head is less likely to hit the teeth nor causing damage to the gums. Therefore, the target motion range is determined to be relatively large, so that the brush head of the toothbrush 100 is able to cover the tooth surfaces as much as possible during the brushing process, thereby improving the cleaning efficiency. When the oral health data indicates that the oral cavity is relatively unhealthy, it means that the oral cavity of the user is more sensitive. If the rotation angle of the brush head is large, the brush head is more likely to hit the teeth and cause the damage to the gums. Therefore, the target motion range is determined to be small, so that the brush head of the toothbrush 100 is prevented from causing damage to the oral cavity during the brushing process.

Optionally, before the toothbrush 100 enters the working state, the toothbrush 100 determines the target motion range corresponding to the rotor 130 of the motor 20 according to the oral health data, and controls the rotor 130 of the motor 20 to move according to the target motion range to drive the brush head to brush the teeth. During the brushing process of the toothbrush 100, the target motion range corresponding to the rotor 130 of the motor 20 is allowed to be unchanged.

In some embodiments, the toothbrush 100 determines the target motion range corresponding to the rotor 130 of the motor 20 according to the real-time brushing data. During the brushing operation of the toothbrush 100, the toothbrush 100 determines the target motion range corresponding to the rotor 130 of the motor 20 according to the real-time brushing data. If the real-time brushing data indicates that the brush head is currently in an oral area where teeth are more likely to be hit (such as the tooth surfaces and/or tooth areas where the teeth are more likely to be hit), the target motion range is determined to be small, thereby preventing the brush head from hitting the teeth during the brushing process and protecting the oral health of the user. If the real-time brushing data indicates that the brush head is currently in an oral area where the teeth are less likely to be hit, the target motion range is determined to be large, thereby increasing the coverage of the tooth surfaces by the bristles on the brush head during the brushing process, and improving the cleaning efficiency and the cleaning effect.

Optionally, cleaning requirements corresponding to an oral area or a tooth area where the brush head is currently located is also determined according to the real-time brushing data, and the target motion range matching the cleaning requirements is determined accordingly. For instance, when it is determined that the brush head is in an alveolar or fissure and groove according to the real-time brushing data, the target motion range is determined to be small, so that the rotor 130 of the motor 20 moves in a small range of the target motion range, thereby driving the brush head to perform the brushing operation at a small rotation angle, making it easier to clean the oral area such as the alveolar or fissure. Alternatively, when it is determined that the brush head is on an outer side surface of the teeth according to the real-time brushing data, the target motion range is determined to be large, thereby increasing the coverage of the tooth surfaces by the brush head during the brushing process, so as to improve the cleaning efficiency and cleaning effect of the toothbrush 100.

In some embodiments, the toothbrush 100 determines the target motion range corresponding to the rotor 130 of the motor 20 according to the oral health data and the real-time brushing data. Optionally, the toothbrush 100 determines the target motion range corresponding to the rotor 130 of the motor 20 according to the oral health data before entering the working state, and adjusts the target motion range according to the real-time brushing data during the brushing operation. Moreover, the oral health data of the user and the real-time brushing data are combined to further effectively prevent the brush head from hitting the teeth or damaging the gums during the brushing operation while ensuring the cleaning effect of the toothbrush 100.

The step 230 comprises controlling the rotor 130 to reciprocate in the circumferential direction within the target motion range to drive the brush head of the toothbrush to brush the teeth.

When the toothbrush 100 is in the working state, the toothbrush 100 controls the rotor 130 to reciprocate in the circumferential direction within the target motion range. The target motion range refers to a motion range of the rotor 130 to reciprocate in the circumferential direction when the motor 20 is in the running state. Optionally, the target motion range is defined with reference to a zero position and deflection angles relative to the zero position. The zero position is a midpoint position of the target motion range. For example, the zero position is defined as a position where the rotor rotates 0 degrees, and the target motion range is −10-10 degrees. The rotor 130 reciprocates in the circumferential direction between a position 10 degrees counterclockwise relative to the zero position and a position 10 degrees clockwise relative to the zero position.

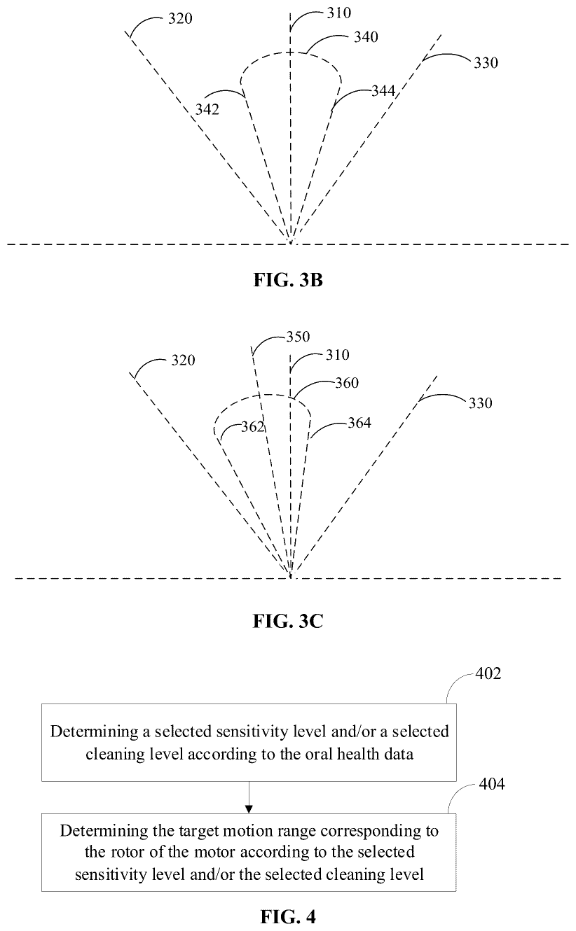

FIG. 3A is a schematic diagram of the target motion range of the rotor of the motor according to one embodiment of the present disclosure. As shown in FIG. 3A, the target motion range comprises a first extreme position 320 and a second extreme position 330. The zero position 310 is a midpoint position between the first extreme position 320 and the second extreme position 330. The rotor 130 of the motor 20 is able to reciprocate within the target motion range.

In some embodiments, a reciprocating motion of the rotor 130 in the circumferential direction is divided into swing and rotation When the toothbrush 100 is in the working state, the toothbrush 100 controls the rotor 130 of the motor 20 to perform reciprocating swing in the circumferential direction with the reference position as the reference zero axis. The reciprocating swing refers to a reciprocating motion of the rotor 130 in the circumferential direction with the reference zero axis as a center. The rotation of the rotor 130 is for adjusting the reference position of the rotor 130 when the rotor 130 of the motor 20 performs the reciprocating swing, so that the brush head performs a vibration operation and a sweeping operation during the brushing operation. The rotor 130 performs the reciprocating swing with the reference position as the reference zero axis, which drives the brush head to vibrate. The rotor 130 rotates to change the reference position when performs the reciprocating swing, which drives the brush head to swing significantly, thereby increasing the cleaning area of the brush head and realizing a sweeping and vibration function of the brush head.

FIG. 3B is a schematic diagram of a reciprocating swing range of the rotor with the reference position as the reference zero axis according to one embodiment of the present disclosure. As shown in FIG. 3B, when the rotor 130 performs the reciprocating swing with the zero position 310 as the reference zero axis, the reciprocating swing range is defined as a swing interval 340, and the position of the rotor 130 changes back and forth between a position 342 and a position 344. The rotor 130 performs the reciprocating swing with the zero position 310 as the reference zero axis. Namely, the rotor 130 swings in a clockwise swing direction around the zero position 310 (the reference zero axis) to reach the position 344, then the rotor 130 swings in a counterclockwise swing direction from the position 344 to reach the position 342, and then the rotor 130 swings in the clockwise swing direction from the position 342 to reach the zero position 310, which is considered as one reciprocating swing. The rotor 130 is able to perform the reciprocating swing for multiple times in one swing cycle, and the reference position of the rotor 130 in one swing cycle remains unchanged.

FIG. 3C is a schematic diagram of a possible reference position of the rotor according to one embodiment of the present disclosure. The reference position is changed by controlling the rotor 130 to rotate. For instance, as shown in FIG. 3C, the rotor 130 is controlled to rotate to switch the reference position from the zero position 310 to a position 350, and the rotor 130 performs the reciprocating swing with the position 350 as the reference zero axis, and the reciprocating swing range of is a swing interval 360, and the position of the rotor 130 changes back and forth between a position 362 and a position 364. For instance, the rotor 130 is able to swing from the position 350 to the position 362, then swing from the position 362 to the position 364, and then swing from the position 364 to the position 350. This process are repeated to realize reciprocating swing of the rotor 130.

In some embodiments, according to the target motion range, the rotor 130 is controlled to perform the reciprocating swing based on the swing parameters with the reference position as the reference zero axis, and the rotor 130 is controlled to rotate based on the rotation parameters to change the reference position.

Optionally, the swing parameters comprise, but are not limited to one or more of a swing direction, a swing angle, a swing frequency, a duration corresponding to the swing cycle, etc. The swing direction comprises the clockwise swing direction and the counterclockwise swing direction of the rotor 130 in the circumferential direction, etc. The clockwise swing direction is opposite to the counterclockwise swing direction. The swing angle refers to an angle corresponding to a single reciprocating swing of the rotor 130 in the circumferential direction. Taking FIG. 3B as an example, the swing angle refers to an angle between the position 342 and the position 344. The swing angle is further understood as a swing amplitude corresponding to a single swing cycle. The swing frequency refers to the number of times the rotor 130 performs the reciprocating swings in one swing cycle. In one embodiment, the swing parameters comprises the swing frequency and the swing amplitude.

Optionally, the rotation parameters comprise, but are not limited to one or more of a rotation direction, a rotation angle, a rotation frequency, etc. The rotation direction comprises a clockwise rotation direction and a counterclockwise rotation direction of the rotor 130 in the circumferential direction. The clockwise rotation direction is opposite to the counterclockwise rotation direction. The rotation angle refers to an angle between latest two reference positions of the rotor 130. Taking FIG. 3C as an example, when the reference position of the rotor 130 is switched from the zero position 310 to the position 350, the rotation angle is an included angle between the position 350 and the zero position 310. The rotation frequency refers to switching times of the reference position per unit time. Optionally, the rotation frequency may be 5 times/second, 8 times/second, 10 times/second, etc., which is not limited thereto. The rotation frequency affects the duration corresponding to the swing cycle. The duration corresponding to the swing cycle may be the unit time divided by the rotation frequency. For example, if the rotation frequency is 10 times/second, the duration corresponding to the single swing cycle is 0.1 seconds. In some embodiments, the rotation frequency of the rotor 130 is less than the swing frequency. Since the reciprocating swing of the rotor 130 is mainly configured to clean the teeth, when the swing frequency is set to be large, the cleaning effect improves. The rotation frequency of the rotor 130 is to change a cleaning range of the brush head, so the rotation frequency is allowed to be relatively low; so that each cleaning range is allowed to have enough cleaning time to ensure the cleaning effect. Optionally, the rotation frequency is 5 times/second, 8 times/second, 10 times/second, etc., and the swing frequency is 200 Hz (Hertz), 300 Hz, 500 Hz, 650 Hz, etc., which is not limited thereto. The swing frequency is an order of magnitude higher than the rotation frequency.

The toothbrush 100 controls the rotor 130 to swing back and forth and rotate within a determined target motion range according to the determined target motion range. The toothbrush 100 determines a reference position range corresponding to the reference position of the rotor 130 according to the determined target motion range, and the toothbrush 100 controls the rotor 130 to change the reference position within the reference position range. The reference position range is less than the determined target motion range.

In some embodiments, the target motion range comprises the first extreme position and the second extreme position, and the zero position is the midpoint position of the first extreme position and the second extreme position. The reference position range comprises a first extreme reference position and a second extreme reference position, and the zero position is also a midpoint position of the first extreme reference position and the second extreme reference position. The first extreme reference position and the second extreme reference position are determined according to the first extreme position and the second extreme position. Furthermore, the first extreme reference position is between the first extreme position and the second extreme position, and a position difference between the first extreme position and the first extreme reference position is equal to ½ of the swing angle. The second extreme reference position is between the first extreme position and the second extreme position, and a position difference between the second extreme position and the second extreme reference position is equal to ½ of the swing angle. Therefore, the motor 20 is accurately controlled to reciprocate within the target motion range, and the position of the rotor 130 of the motor 20 is ensured to be within the target motion range during the brushing operation, which realizes accurate control of the motion of the rotor 130, further prevents the brush head from hitting the teeth during the use of the toothbrush 100, and improve the cleaning effect.

In the embodiments of the present disclosure, the toothbrush 100 obtains the oral health data and/or the real-time brushing data. The toothbrush 100 determines the target motion range corresponding to the rotor 130 of the motor 20 according to the oral health data and/or the real-time brushing data, and controls the rotor 130 to reciprocate in the circumferential direction within the target motion range to drive the brush head to brush the teeth. The toothbrush 100 determines the target motion range of the rotor 130 of the adapted motor 20 according to the oral health data and/or the real-time toothbrush 100 data, and adaptively adjust the target motion range of the rotor 130 of the motor 20, so that the determined target motion range is more in line with the actual situation of the oral cavity of the user, and the maximum rotation angle of the brush head is flexibly adjusted, which effectively prevents the brush head from hitting the teeth during the use of the toothbrush 100, ensures the oral health of the user, and improves the use experience of the user.

As shown in FIG. 4, in one embodiment, a step of determining the target motion range corresponding to the rotor of the motor of the toothbrush according to the oral health data comprises steps 402-404.

The step 402 comprise determining a selected sensitivity level and/or a selected cleaning level according to the oral health data.

Sensitivity levels indicate the sensitivity of the oral cavity of the user. Optionally, the higher the selected sensitivity level, the higher the sensitivity of the oral cavity of the user. Cleaning levels indicate a degree to which the oral cavity needs to be cleaned. Optionally, the higher the selected cleaning level, the more serious the oral cavity need to be cleaned, and the higher a cleaning degree.

In some embodiments, the toothbrush 100 determines the selected sensitivity level based on one or more information such as the gum health level, the dental caries information, and the oral disease information. Optionally, the sensitivity levels are predetermined based on corresponding relationships between information (such as the gum health level, the dental caries information, and the oral disease information) and each of the sensitivity levels. For example, the sensitivity levels include three levels: insensitivity, mild sensitivity, and severe sensitivity. The gum health level, the dental caries information, and the oral disease information corresponding to insensitivity are respectively “very healthy”, “no caries”, and “no disease”, etc. The gum health level, the dental caries information, and the oral disease information corresponding to mild sensitivity are respectively “generally healthy/ordinary healthy”, “no caries”, and “no disease/mild oral ulcers”, etc. The gum health level, the dental caries information, and the oral disease information corresponding to severe sensitivity are respectively “unhealthy”, “at least one caries”, and “periodontitis or severe oral ulcers”, etc.

In some embodiments, the toothbrush 100 determines the selected cleaning level according to information such as the amount of the dental plaque residue. The less the amount of the dental plaque residue, the cleaner the oral cavity is, and the smaller the selected cleaning level. Optionally, the cleaning levels are predetermined and a range of the dental plaque residues corresponding to each of the cleaning levels is determined. After obtaining the amount of the dental plaque residue, the range to which the amount of the dental plaque residue belongs is determined, and the selected cleaning level corresponding to the range of the amount of the dental plaque residues is determined.

It should be noted that the selected sensitivity level and the selected cleaning level may also be determined by other methods. For example, big data analysis or neural network analysis are adopted to determine the selected sensitivity level and the selected cleaning level, which is not limited thereto.

The step 404 comprises determining the target motion range corresponding to the rotor of the motor according to the selected sensitivity level and/or the selected cleaning level. The target motion range corresponding to the rotor is in a negative correlation with the selected sensitivity level, and the target motion range corresponding to the rotor is in a positive correlation with the selected cleaning level.

When the selected cleaning level is determined, the target motion range is negatively correlated with the selected sensitivity level. The higher the selected sensitivity level, the more sensitive the oral cavity is. If the rotation angle of the brush head is large, the brush head is easy to damage the oral cavity. For example, if the rotation angle of the brush head is too large, the brush head is easy to damage the gums. Therefore, the target motion range is determined to be small to reduce the maximum rotation angle of the brush head and protect the oral cavity of the user.

When the selected sensitivity level is determined, the target motion range is positively correlated with the selected cleaning level. The higher the selected cleaning level, the greater the cleaning degree required by the user. Therefore, the target movement range is determined to be large, which increases the coverage of the oral areas by the bristles of the brush head and improves the cleaning effect.

In some embodiments, the toothbrush 100 determines a first motion range corresponding to the selected sensitivity level and a second motion range corresponding to the selected cleaning level. The toothbrush compares the first motion range with the second motion range, and determines a smaller one of the first motion range and the second motion range as the target motion range corresponding to the rotor 130 of the motor 20. Alternatively, the toothbrush 100 determines the first motion range corresponding to the selected sensitivity level and the second motion range corresponding to the selected cleaning level, and the toothbrush 100 calculates an average of the first motion range and the second motion range as the target motion range corresponding to the rotor 130 of the motor 20. Alternatively, the user may set importance coefficients corresponding to the selected sensitivity level and the selected cleaning level according to his or her own needs. The first motion range and the second motion range are weighted and calculated to obtain the target motion range corresponding to the rotor 130 of the motor 20.

In the embodiment of the present disclosure, sensitivity and cleaning requirements of the oral cavity are comprehensively considered to determine the target motion range corresponding to the rotor 130 of the motor 20, while taking into account the oral health of the user and cleaning effect, thereby improving the use experience.

In some embodiments, the step of determining the target motion range corresponding to the rotor 130 of the motor 20 according to the oral health data comprises inputting the oral health data into a pre-trained neural network, and analyzing the oral health data through the pre-trained neural network to determine the target motion range corresponding to the rotor 130 of the motor 20. The pre-trained neural network is trained based on a plurality of sample data, and each sample data includes sample oral health data and a corresponding motion range of the motor 20.

Specifically, a large amount of sample data is collected in advance, and each sample data comprises the sample oral health data and the corresponding motion range of the motor 20, where the corresponding motion range of the motor 20 is determined through experiments and is less likely to cause hitting of the teeth while ensuring a certain cleaning ability. The plurality of sample data is input into a to-be-trained neural network. The to-be-trained neural network extracts data features of each sample oral health data, and analyze the extracted data features to obtain predicted motion ranges, and each of the predicted motion ranges is compared with a corresponding motion range of the motor 20 corresponding to each sample oral health data. An error between each of the predicted motion ranges and the corresponding motion range of the motor 20 is calculated, and parameters in the to-be-trained neural network are adjusted according to each error until the to-be-trained neural network converges to obtain the pre-trained neural network. The pre-trained neural network has the ability to determine a proper target motion range based on the oral health data of the user. It should be noted that a training process thereof are carried out on a cloud server or on an electronic device.

The pre-trained neural network may be stored in the toothbrush 100. After obtaining the oral health data of the user, the toothbrush 100 inputs the oral health data of the user into the pre-trained neural network. The pre-trained neural network extracts data features of the oral health data of the user and analyzes extracted data features to determine the target motion range corresponding to the rotor 130 of the motor 20.

In the embodiments of the present disclosure, the target motion range corresponding to the rotor 130 of the motor 20 is determined according to oral health data by artificial intelligence (AI), which makes the determined target motion range accurate, further effectively prevents the brush head from hitting the teeth during the use of the toothbrush 100, and ensures the cleaning effect of the oral cavity.

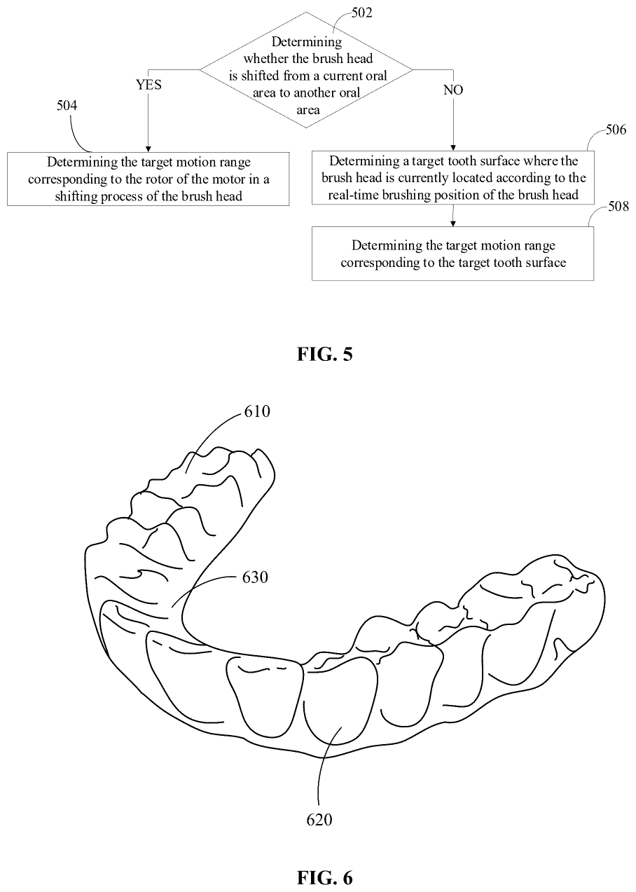

As shown in FIG. 5, in some embodiments, the step of determining the target motion range corresponding to the rotor 130 of the motor 20 according to the real-time brushing data comprises steps 502-508.

The step 502 comprises determining whether the brush head is shifted from a current oral area to another oral area according to the real-time brushing data, if yes, executing the step 504, and if not, executing the step 506.

When the brush head is shifted between any two of the oral areas, the brush head is shifted from the current oral area to another oral area. The oral areas comprise, but are not limited to the tooth areas, a tongue area, etc. When the toothbrush 100 is in the working state, the toothbrush 100 obtains the real-time brushing data and determines whether the brush head is shifted between any two of the oral areas according to the real-time brushing data.

In some embodiments, the real-time brushing data comprises the real-time motion state. The real-time motion state comprises, but is not limited to a real-time moving speed, a moving direction, etc. It is determine whether the brush head is shifted between any two of the oral areas according to the real-time motion state. For example, when it is detected that the real-time moving speed of the toothbrush 100 is greater than a first speed threshold, it indicates that the user actively controls the toothbrush 100 to move a long distance. In this case, there is a high probability of oral area switching, so it is determined that the brush head is shifted between two of the oral areas. When it is detected that the real-time moving speed of the toothbrush 100 is not greater than the first speed threshold, it is determined that the current oral area where the brush head is located is not switched.

In some embodiments, the real-time brushing data comprises a real-time brushing pressure, and whether the brush head is shifted between any two of the oral areas is determined according to the real-time brushing pressure. For example, when it is detected that the real-time brushing pressure of the toothbrush 100 is less than a first pressure threshold, it indicates that the bristles are not attached to the tooth surfaces. In this case, there is a high probability of oral area switching of the oral areas, and it is determined that the brush head is shifted between two of the oral areas. When it is detected that the real-time brushing pressure of the toothbrush 100 is not less than the first pressure threshold, it indicates that the bristles for brushing are in contact with the tooth surfaces, and the brushing operation is performed on the tooth surfaces, and it is determined that the brush head does not shift between different oral areas.

In some embodiments, the real-time brushing data comprises the real-time brushing position, and whether the brush head is shifted between any two of the oral areas is determined based on the real-time brushing position. For example, a plurality of continuous real-time brushing positions are obtained, and position change information, such as a position change distance, a position change speed, etc., of the brush head is determined according to the plurality of continuous real-time brushing positions. Further, whether the oral areas are switched is determined based on the position change information. When the position change information indicates that the brushing position changes significantly (for example, the position change distance is greater than a distance threshold, or the position change speed is greater than a second speed threshold, etc.), it is determined that the brush head is shifted between different oral areas. When the position change information indicates that the brushing position changes slightly (for example, the position change distance is not greater than the distance threshold, or the position change speed is not greater than the second speed threshold, etc.), it is determined that the brush head does not shift between different oral areas.

It should be noted that the toothbrush 100 is able to determine whether the brush head is shifted between different oral areas by combining variety of real-time brushing data. For example, whether the brush head shifts between different oral areas is determined according to the real-time motion state and real-time brushing pressure, which is not limited thereto.

The step 504 comprises determining the target motion range corresponding to the rotor 130 of the motor 20 in the shifting process of the brush head.

In the shifting process of the brush head, the brush head is easy to hit the teeth. Therefore, the target motion range corresponding to the rotor 130 of the motor 20 is reduced. During the shifting process, the target motion range corresponding to the rotor of the motor is less than the target motion range corresponding to the rotor of the motor when the brush head is in any one of the oral areas. In this way, the brush head is prevented from hitting the teeth during a moving process of the brush head, which ensures the oral health of the user and improves the use experience of the user.

The step 506 comprises determining a target tooth surface where the brush head is currently located according to the real-time brushing position of the brush head.

The step 508 comprises determining the target motion range corresponding to the target tooth surface.

When the brush head does not shift between different oral areas, the bristles of the brush head are in contact with the tooth surfaces and brush the tooth surfaces to clean the teeth of the user. During the brushing operation, the toothbrush 100 determines the target tooth surface where the brush head is currently located according to the real-time brushing position of the brush head. Different target motion ranges correspond to different tooth surfaces.

In some embodiments, the target tooth surface is any one of an occlusal surface, an outer side surface, and an inner side surface of the teeth. The occlusal surface of the teeth refers to a surface of the teeth configured for biting. The outer side surface of the teeth refers to a surface of the teeth close to lips. The inner side surface of the teeth refers to a surface of the teeth close to a tongue. FIG. 6 is a schematic diagram of tooth surfaces according to one embodiment of the present disclosure. As shown in FIG. 6, the occlusal surface 610 of the teeth refers to the surface of the teeth configured for biting. The outer side surface 620 of the teeth refers to the surface of the teeth close to the lips. The inner side surface 630 of the teeth refers to a surface of the teeth close to the tongue.

The target motion range corresponding to the occlusal surface of the teeth is not greater than the target motion range corresponding to the inner side surface of the teeth. The target motion range corresponding to the inner side surface of the teeth is less than the target motion range corresponding to the outer side surface of the teeth.

When the brush head is on the occlusal surface for brushing, due to the different open degrees of the mouths of different users, the brush head is easier to hit the teeth when the brush head brushes on the occlusal surface. Therefore, the target motion range of the rotor 130 of the motor 20 is made small to reduce the rotation angle of the brush head, thereby reducing the movement range of the brush head and reducing a risk of hitting teeth. Moreover, when the brush head moves at a small rotation angle, it is easier to clean the pits and grooves of the occlusal surface, thereby improving the cleaning effect. When the brush head is on the inner side surface of the teeth for brushing, it is also easy to hit the teeth, but the probability of hitting teeth thereof is lower than the probability of hitting teeth when the brush head is on the occlusal surface. Therefore, the target motion range corresponding to the inner side surface is not less than the target motion range corresponding to the occlusal surface of the teeth, while taking into account the situation of hitting teeth and cleaning needs. When the brush head is on the outer side surface of the teeth, the brush head is not easy to hit the teeth. Therefore, the target motion range of the rotor 130 of the motor 20 is made large to increase the rotation angle of the brush head, thereby increasing the cleaning coverage of the bristles and improving the cleaning efficiency and cleaning effect.

In some embodiments, when the toothbrush is determined to be in a non-tooth-surface area according to the real-time brushing position, a target motion range corresponding to the non-tooth-surface area is determined, and the target motion range corresponding to the non-tooth-surface area is not greater than a target motion range corresponding to a tooth surface.

When the toothbrush 100 is in the non-tooth surface area, the brush head may shift between different oral areas, or the brush head may clean a tongue area of the user, etc. Since the brush head is easy to hit the teeth when the brush head shifts between different oral areas, and in order to avoid excessive stimulation to the tongue when the brush head cleans the tongue area of the user, it is necessary to reduce the target motion range of the rotor 130 of the motor 20, so as to reduce the rotation angle of the brush head and reduce the risk of hitting teeth or to avoid stimulation to the tongue of the user.

In some embodiments, during the brushing operation of the toothbrush 100, it is determined whether the real-time brushing pressure is greater than a second pressure threshold (the second pressure threshold is greater than the first pressure threshold). When the real-time brushing pressure is greater than the second pressure threshold, it indicates that the teeth is under too much pressure, so the target motion range of the rotor 130 is reduced, thereby reducing the rotation angle of the brush head to avoid damage to the oral cavity of the user and ensure the oral health of the user.

In the embodiments of the present disclosure, the toothbrush 100 determines the target motion range corresponding to the rotor 130 of the motor 20 according to the real-time brushing data, and adjusts the target motion range corresponding to the rotor 130 according to a specific situation during the brushing process. Therefore, the toothbrush 100 is effectively prevented from hitting the teeth during the use of the toothbrush 100, thereby ensuring the oral health of the user and improving the use experience, while taking into account the cleaning effect of the toothbrush 100.

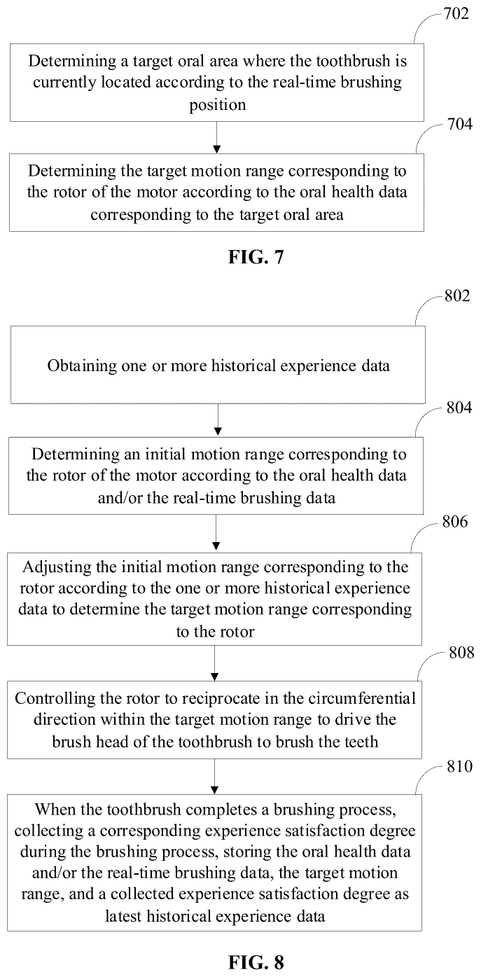

As shown in FIG. 7, in one embodiment, the step of determining the target motion range corresponding to the rotor of the motor of the toothbrush according to the oral health data and the real-time brushing data comprises steps 702 and 704.

The step 702 comprises determining a target oral area where the toothbrush 100 is currently located according to the real-time brushing position.

The step 704 comprises determining the target motion range corresponding to the rotor of the motor 20 according to the oral health data corresponding to the target oral area.

In some embodiments, the oral health data comprises oral health data corresponding to different oral areas. For instance, each oral health data comprises one or more of the gum health level, the dental caries information, the dental plaque residue, and the oral disease information, etc., corresponding to each of the oral areas. During the brushing operation of the toothbrush 100, the toothbrush 100 obtains the real-time brushing position of the brush head, determines the target oral area where the toothbrush 100 is currently located, and determines the target motion range corresponding to the rotor 130 of the motor 20 according to the oral health data corresponding to the target oral area. It should be noted that a method of determining the target motion range corresponding to the rotor 130 of the motor 20 according to the oral health data corresponding to the target oral area is similar to the method of determining the target motion range corresponding to the rotor 130 of the motor 20 according to the oral health data described in the above embodiments, and is not repeatedly illustrated herein.

In other embodiments, before the toothbrush 100 performs the brushing operation, the target motion range corresponding to each of the oral areas is determined according to the oral health data corresponding to each of the oral areas. During the brushing operation of the toothbrush 100, the target oral area where the toothbrush 100 is currently located is determined according to the real-time brushing position, and according to the target motion range corresponding to the target oral area, the rotor 130 is controlled to reciprocate in the circumferential direction within the target motion range to drive the brush head to perform the brushing operation.

According to the oral health data corresponding to each of the oral areas, the target motion range corresponding to the rotor 130 of the motor 20 is determined. For oral areas with different health conditions, different values of the target motion range of the rotor 130 are adapted, so that the rotation range of the brush head is flexibly adjusted, so that the brush head moves at a smaller rotation angle in the oral areas that are sensitive and unhealthy, and the brush head moves at a larger rotation angle in the oral areas that needs cleaning or are healthier, thereby improving the oral cleaning and care effect.

In some embodiments, before the toothbrush 100 performs the brushing operation, the target motion range corresponding to the rotor 130 of the motor 20 is determined according to the oral health data, then the rotor 130 is controlled to reciprocate in the circumferential direction within the target motion range to drive the brush head to perform the brushing operation. During the brushing operation, the target motion range is adjusted according to the real-time brushing data of the toothbrush 100, and the rotor 130 is controlled to reciprocate in the circumferential direction within an adjusted target motion range to drive the brush head to perform the brushing operation.

The toothbrush 100 first determines the target motion range corresponding to the rotor 130 of the motor 20 according to the oral health data, and controls the rotor 130 to reciprocate in the circumferential direction within the target motion range. At the same time, the target motion range of the rotor 130 is adjusted according to the real-time brushing data of the toothbrush 100. For example, when it is detected that the brush head shifts between different oral areas according to the real-time brushing data, the target motion range of the rotor 130 is reduced. When it is detected that the brush head is on the occlusal surface according to the real-time brushing data, the target motion range of the rotor 130 is reduced. When it is detected that the brush head is on the outer side surface of the teeth according to the real-time brushing data, the target motion range corresponding to the outer side surface of the teeth is restored to be the target motion range determined according to the oral health data (that is, the target motion range of the rotor 130 is not adjusted).

In the embodiments of the present disclosure, the toothbrush 100 determines the target motion range corresponding to the rotor 130 of the motor 20 by the oral health data and the real-time brushing data, the target motion range of the rotor 130 of the motor 20 is adaptively adjusted, so that the motion range of the rotor 130 is more in line with the actual situation of the oral cavity of the user, which effectively prevents the brush head from hitting the teeth during the use of the toothbrush 100, ensures the oral health of the user, and improves the use experience of the user.

In addition to determining the target motion range of the rotor 130 of the motor 20 according to the oral health data and the real-time brushing data, the toothbrush 100 is further able to comprehensively consider satisfaction of the user during the brushing process to further adjust the target motion range of the rotor 130, which better meets the actual needs of the user.

As shown in FIG. 8, in another embodiment, the present disclosure provides a control method of the toothbrush 100 that is applied to the toothbrush 100 mentioned above. As shown in FIG. 8, the control method comprises steps 802-810.

The step 802 comprises obtaining one or more historical experience data.

The one or more historical experience data refers to the user experience data collected after historical brushing operations of the toothbrush 100. Each historical experience data comprise a historical motion range, historical oral health data and/or historical real-time brushing data corresponding to the historical motion range, and an experience satisfaction degree corresponding to the historical motion range.

For better understanding of the present disclosure, the embodiment hereby takes an example that only one historical experience data is provided for ease of illustration.

The historical motion range refers to the target motion range of the rotor 130 corresponding to the historical brushing process of the historical experience data. During the historical brushing process corresponding to the historical experience data, the toothbrush 100 may control the rotor 130 of the motor 20 to reciprocate in a circumferential direction according to the historical motion range.

The historical oral health data and/or the historical real-time brushing data corresponding to the historical motion range refers to the historical oral health data and/or the historical real-time brushing data corresponding to the historical brushing process corresponding to the historical experience data. The historical motion range is determined based on the historical oral health data and/or the historical real-time brushing data.

The experience satisfaction degree corresponding to the historical motion range refers to the satisfaction of the user during the historical brushing process corresponding to the historical experience data. Optionally, the experience satisfaction degree may be represented by a satisfaction score. For example, the higher the satisfaction score, the more satisfied the user is during the brushing process, and the higher the experience satisfaction degree. The lower the satisfaction score, the less satisfied the user is during the brushing process, and the lower the experience satisfaction degree. Furthermore, in addition to the satisfaction score, the experience satisfaction degree further comprises other experience data, such as whether the teeth are hit during the brushing process, whether the user is satisfied with the cleaning effect during the brushing process, whether there is discomfort such as tingling during the brushing process, etc. By collecting the experience satisfaction degree of the user during each brushing process, the toothbrush 100 is able to analyze whether the determined target motion range of the rotor 130 of the motor 20 during the brushing process is appropriate, thereby adjusting the target motion range of the rotor 130.

The step 804 comprises determining an initial motion range corresponding to the rotor of the motor according to the oral health data and/or the real-time brushing data.

The step 806 comprises adjusting the initial motion range corresponding to the rotor according to the one or more historical experience data to determine the target motion range corresponding to the rotor.

When the toothbrush 100 needs to perform a current brushing process, the toothbrush 100 determines the initial motion range of the rotor 130 of the motor according to the oral health data oral data and/or the real-time brushing data. It should be noted that the method of determining the initial motion range of the motor rotor 130 according to the oral health data and/or the real-time brushing data is similar to the method of determining the target motion range of the rotor 130 of the motor according to the oral health data and/or the real-time brushing data described in the above embodiments, which is not repeatedly illustrated herein.

In some embodiments, the toothbrush 100 compares a current initial motion range, a current oral health data and/or a current real-time brushing data with the one or more historical experience data, and retrieves the historical oral health data and/or historical real-time brushing data that are similar to the current oral health data and/or the current real-time brushing data as target historical experience data. The historical motion range and experience satisfaction degree contained in each target historical experience data are obtained, and the historical motion range contained in each target historical experience data is compared with the current initial motion range. If the historical motion range is the same as or close to the current initial motion range (for example, a range difference between the historical motion range and the current initial motion range is less than a difference threshold), it is determined whether the current initial motion range needs to be adjusted according to the experience satisfaction degree corresponding to the historical motion range.

Optionally, if there is one historical motion range in a specific target historical experience data is the same as or very close to the current initial motion range, and the experience satisfaction degree corresponding to the one historical motion range in the specific target historical experience data is good (for example, the satisfaction score thereof is greater than a first score threshold), then there is no need to adjust the current initial motion range, and the current initial motion range is determined as the target motion range. if there is one historical motion range in a specific target historical experience data is the same as or very close to the current initial motion range, and the experience satisfaction degree corresponding to the one historical motion range in the specific target historical experience data is poor (for example, the satisfaction score thereof is less than a second score threshold, and the second score threshold is not greater than the first score threshold), then the current initial motion range is adjusted to determine the target motion range. Furthermore, the current initial motion range is adjusted according to the specific target historical experience data corresponding to the one historical motion range. For example, if the user feedback shows that the teeth are hit, the current initial motion range is reduced: or, if the user feedback shows that the cleaning effect is not good, the initial motion range is increased, etc., which is not limited thereto.

In another embodiment, after determining the specific target historical experience data, one target historical motion range with good experience satisfaction degree (for example, the satisfaction score thereof is greater than the first score threshold) is retrieved from the specific target historical experience data, and the specific target historical motion range and the current initial motion range are averaged or are weighted and calculated, etc., to obtain the target motion range corresponding to the rotor 130 of the motor 20.

By screening out the specific target historical experience data that is similar to the current initial motion range, the current oral health data, and/or the current real-time brushing data, and adjusting the current initial motion range according to the one historical motion range and the corresponding experience satisfaction degree in the specific target historical experience data, the determined target motion range of the rotor 130 of the motor 20 is more in line with the actual needs of the user, thereby ensuring the experience satisfaction of the user during the brushing process.

The step 808 comprises controlling the rotor to reciprocate in the circumferential direction within the target motion range to drive the brush head of the toothbrush to brush the teeth.

Details of the step 808 may refer to the descriptions in the above embodiments, which are not repeatedly illustrated herein.

The step 810 comprises when the toothbrush completes a brushing process, collecting a corresponding experience satisfaction degree during a brushing process, storing the oral health data and/or the real-time brushing data, the target motion range, and a collected experience satisfaction degree as latest historical experience data.

When the toothbrush 100 completes a latest brushing process, for example, a duration of a latest brushing operation reaches a target brushing time, the user actively exits the working state, etc., the toothbrush 100 collects the experience satisfaction with the brushing process, and store the oral health data and/or real-time brushing data, the target motion range and the collected experience satisfaction degree correspondingly as the latest historical experience data, so that the toothbrush 100 is able to adjust the target motion range of the rotor 130 of the motor 20 during subsequent brushing processes.

In one embodiment of the present disclosure, after the toothbrush 100 determines the initial motion range corresponding to the rotor 130 of the motor 20 according to the oral health data and/or the real-time brushing data, the initial motion range is adjusted according to the one or more historical experience data to determine the target motion range, and the target motion range of the rotor 130 is further adjusted by comprehensively considering the satisfaction degree of the use during the brushing process, so that the determined target motion range of the rotor 130 of the motor 20 is more in line with the actual needs of the user, thereby ensuring the experience satisfaction degree of the use during the brushing process.

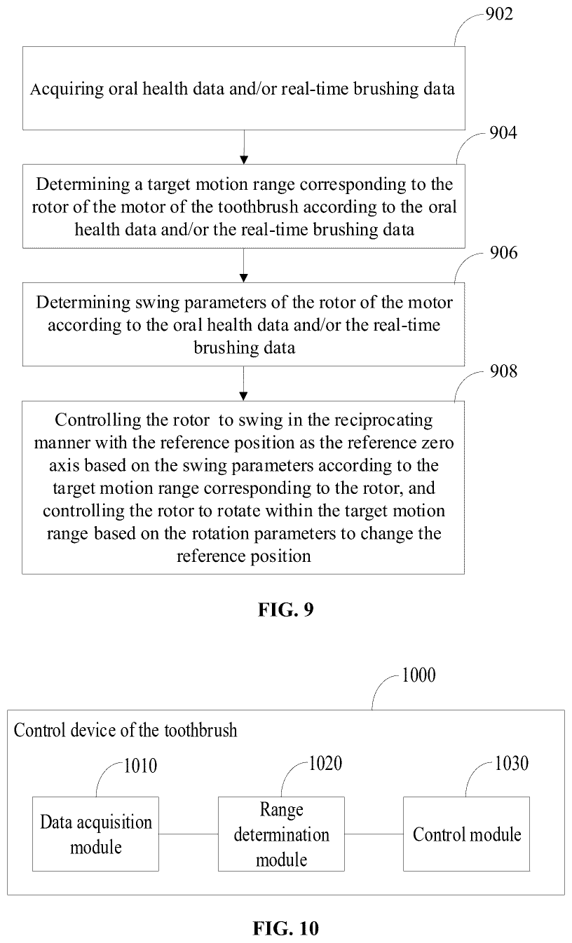

In addition to determining the target motion range of the rotor 130 of the motor 20 according to the oral health data and/or the real-time brushing data, the toothbrush 100 is also able to determine the swing parameters of the rotor 130 of the motor 20 according to the oral health data and/or the real-time brushing data. As shown in FIG. 9, in another embodiment, the present disclosure provides a control method of the toothbrush 100 applied to the toothbrush 100 mentioned above.

The control method comprises steps 902-908.

The step 902 comprises obtaining oral health data and/or real-time brushing data.

The step 904 comprises determining a target motion range corresponding to the rotor of the motor of the toothbrush according to the oral health data and/or the real-time brushing data.

Details of the steps 902 and 904 may refer to the descriptions in the above embodiments, which are not repeatedly illustrated herein.

The step 906 comprises determining swing parameters of the rotor 130 of the motor 20 according to the oral health data and/or the real-time brushing data.

In some embodiments, the toothbrush 100 determines the swing parameters corresponding to the rotor 130 of the motor 20 according to the oral health data. For example, when the oral health data indicates that the oral cavity of the user is relatively healthy, the swing angle and the swing frequency corresponding to the rotor 130 of the motor 20 are made large, thereby improving the cleaning efficiency and cleaning effect. When the oral health data indicates that the oral cavity of the user is relatively unhealthy, it means that the oral cavity of the user is highly sensitive, and the swing angle and swing frequency corresponding to the rotor 130 of the motor 20 are made small, thereby reducing damage and stimulation to the oral cavity and protecting the oral health of the user.

In some embodiments, the toothbrush 100 determines the swing parameters corresponding to the rotor 130 of the motor 20 according to the real-time brushing data. Optionally, the swing parameters corresponding to the rotor 130 of the motor 20 are determined according to the real-time brushing position of the brush head in the working state, such as determining the swing frequency corresponding to the rotor 130 of the motor 20.

In one embodiment, the target tooth surface where the brush head is located is determined according to the real-time brushing position, and at least one of the swing frequency and the swing amplitude corresponding to the target tooth surface is determined. When the target tooth surface where the brush head is located changes the rotor 130 adjust the swing frequency and/or the swing amplitude accordingly. The target tooth surface is any one of the occlusal surface of the teeth, the outer side surface of the teeth, and the inner side surface of the teeth, a swing frequency corresponding to the occlusal surface of the teeth is greater than a swing frequency corresponding to the outer side surface of the teeth, and the swing frequency corresponding to the occlusal surface of the teeth is greater than a swing frequency corresponding to the inner side surface of the teeth.

When the brush head is on the occlusal surface of the teeth, the rotor 130 has a larger swing frequency, so that the rotor 130 reciprocates with the reference position as the reference zero axis at a higher frequency, and the pits and grooves on the occlusal surface of the teeth are better cleaned, which improves the cleaning effect. Optionally, when it is determined that the brush head is on the occlusal surface of the teeth according to the real-time brushing position, the rotor 130 is controlled to reciprocate with the reference position as the reference zero axis according to the swing parameters corresponding to the occlusal surface of the teeth, and the reference position is kept unchanged. When the brush head is on the occlusal surface of the teeth, the rotor 130 only performs a reciprocating swing motion with the reference position as the reference zero axis without rotating, which further prevents the brush head from hitting the occlusal surface of the teeth and protects the oral health of the user.

In another embodiment, a current target tooth area where the brush head is located is determined according to the real-time brushing position, and at least one of the swing frequency and the swing amplitude corresponding to the current target tooth area is determined.

The teeth in the oral cavity are divided into different tooth areas. For example, the tooth areas comprise, but are not limited to a molar area, an incisor area, a front tooth area, etc. Different tooth areas have different requirements for cleaning. Therefore, for different tooth areas, different target motion ranges of the rotor 130 of the motor 20 are accordingly configured, For example, a saliva flow rate in the molar area is less than a saliva flow rate in the incisor area, and the molar area is more likely to produce dental plaque and has a higher demand for cleaning. Therefore, the target motion range corresponding to the molar area is greater than the target motion range corresponding to the incisor area. During the brushing operation of the toothbrush 100, the toothbrush 100 determines the current target tooth area where the brush head is located according to the real-time brushing position of the brush head, and the toothbrush 100 determines the swing frequency and/or the swing amplitude corresponding to the current target tooth area, so that the rotor 130 is controlled to swing in the reciprocating manner according to at least one of the swing frequency and the swing amplitude with the reference position as the reference zero axis.

The step 908 comprises controlling the rotor 130 to swing in the reciprocating manner with the reference position as the reference zero axis based on the swing parameters according to the target motion range corresponding to the rotor, and controlling the rotor to rotate within the target motion range based on the rotation parameters to change the reference position.

Details of the step 908 may refer to the descriptions in the above embodiments, which are not repeatedly illustrated herein.

In some embodiments, the motor 20 comprises a position sensor, and the toothbrush 100 determines a position limit range corresponding to the target motion range. The toothbrush 100 determines the current position of the rotor 130 through the position sensor. If the current position of the rotor is not within the position limit range, the rotor 130 is controlled to reset to be within the position limit range.

The position limit range is configured to limit a position range of the rotor 130 in the circumferential direction. The position limit range is not less than the target motion range. The position limit range and the target motion range may be the same or are two different ranges. During the brushing operation of the toothbrush 100, the rotor 130 may sometimes exceed the position limit range due to external force, causing the toothbrush 100 to fail to operate normally, affecting the stability and safety of the toothbrush 100, and further affecting the oral cleaning and care effect of the toothbrush 100. Therefore, in the embodiment of the present disclosure, when the toothbrush 100 detects that the current position of the rotor 130 is not within the position limit range, that is, when the current position of the rotor 130 is detected to be exceeded the position limit range, the rotor 130 is controlled to reset to be within the position limit range.

In some embodiments, the position limit range comprises a first position and a second position. The first position and the second position are understood as extreme position points of the rotor. If the current position of the rotor 130 exceeds the first position or the second position, that is, the current position of the rotor 130 is not between the first position and the second position, it means that the current position of the rotor 130 exceeds the position limit range and needs to be reset. The zero position is the midpoint between the first position and the second position. It should be noted that the zero position may also be the first position or the second position. The first position and second position may be determined according to actual needs. The first position and second position may be fixed positions or may change dynamically according to needs. A range of the position limit range (i.e., a position difference between the first position and the second position) is set according to actual needs. Namely, the position limit range is fixed or may change dynamically according to needs, which is not limited thereto.

Optionally, controlling the rotor 130 to reset to be within the position limit range may be understood as controlling the rotor 130 to reset toward the zero position.

In some embodiments, the toothbrush 100 may comprises a reset assembly. When the toothbrush 100 detects that the current position of the rotor 130 is not within the position limit range, the reset assembly is controlled to generate a reset force to drive the rotor 130 to reset to be within the position limit range. Optionally, the reset assembly comprises a magnetic reset piece. For example, the magnetic reset piece comprises a permanent magnet and an electromagnet. The permanent magnet is disposed on the stator module, and the electromagnet is disposed on the rotor 130. When the motor 20 is powered on, and when the current position of the rotor 130 is detected to be not within the position limit range, electric energy is supplied to the electromagnet, and a magnetic force is generated between the electromagnet and the permanent magnet, thereby driving the rotor 130 to rotate toward the position limit range to complete the reset. It should be noted that the toothbrush 100 may control the rotor 130 to reset in other ways, which are not limited thereto.

Optionally, when it is detected that the current position of the rotor 130 is not within the position limit range, the rotor 130 is controlled to stop reciprocating in the circumferential direction first, and the rotor 130 is controlled to reset to be within the position limit range. When the rotor 130 is successfully reset, that is, the current position of the rotor 130 after reset is within the position limit range, the rotor 130 is controlled to continue to reciprocate in the circumferential direction. Therefore, the oral cavity is avoided from damage caused by the reciprocating motion of the rotor 130 when the external force is large, and the oral health of the user is ensured.

In the embodiment of the present disclosure, the toothbrush 100 determines the current position of the rotor 130 of the motor 20 through the position sensor. When the current position of the rotor 130 is not within the position limit range corresponding to the target motion range, the rotor 130 is controlled to reset to be within the position limit range. When the current position of the rotor 130 exceeds the position limit range, the rotor 130 is reset to ensure that the current position of the rotor 130 is within the position limit range. Therefore, a situation where the toothbrush 100 cannot work normally due to the motor 20 exceeding the position limit range is avoided, the stability and safety of the toothbrush 100 are improved, and a normal operation of the toothbrush 100 is ensured.

In the embodiment of the present disclosure, the toothbrush 100 determines the swing parameters corresponding to the rotor 130 of the motor 20 according to the oral health data and/or the real-time brushing data. The swing parameters of the rotor 130 are determined according to the actual conditions of the oral cavity (such as the gum health level, the sensitivity levels, the cleaning requirements, etc.), thereby effectively improving the cleaning effect of the toothbrush 100.

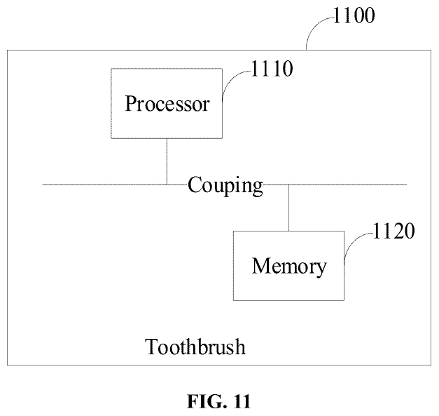

As shown in FIG. 10, in one embodiment, the present disclosure provides a control device of the toothbrush 100. The control device is applied in the toothbrush 100. The control device 1000 of the toothbrush 100 comprises a data acquisition module 1010, a range determination module 1020, and a control module 1030.

The data acquisition module 1010 is configured to obtain the oral health data and/or the real-time brushing data. The range determination module 1020 is configured to determine the target motion range corresponding to the rotor 130 of the motor 20 of the toothbrush according to the oral health data and/or the real-time brushing data. The control module 1030 is configured to control the rotor 130 to reciprocate in the circumferential direction within the target motion range to drive the brush head of the toothbrush to brush the teeth.

In one optional embodiment, the oral health data comprises one or more of the gum health level, the dental caries information, the dental plaque residue, and the oral disease information.

In one optional embodiment, the range determination module 1020 is further configured to determine the selected sensitivity level and/or the selected cleaning level according to the oral health data. The range determination module 1020 is further configured to determine the target motion range corresponding to the rotor of the motor according to the selected sensitivity level and/or the selected cleaning level. The target motion range corresponding to the rotor is in the negative correlation with the selected sensitivity level, and the target motion range corresponding to the rotor is in the positive correlation with the selected cleaning level.

In one optional embodiment, the range determination module 1020 is further configured to input the oral health data into the pre-trained neural network, and analyze the oral health data through the pre-trained neural network to determine the target motion range corresponding to the rotor 130 of the motor 20. The pre-trained neural network is trained based on a plurality of sample data, and each sample data comprises sample oral health data and the corresponding motion range of the motor 20.

In one optional embodiment, the real-time brushing data comprises one or more of the real-time brushing position of the brush head, the real-time brushing pressure, the real-time brushing mode, and the real-time motion state, when the toothbrush is in the working state.

In one optional embodiment, when the brush head is detected to shift between any two of oral areas according to the real-time brushing data, the range determination module 1020 determines the target motion range corresponding to the rotor of the motor during a shifting process. During the shirting process, the target motion range corresponding to the rotor 130 of the motor 20 is less than the target motion range corresponding to the rotor 130 of the motor 20 when the brush head is in any one of the oral areas.

In one optional embodiment, the real-time brushing data comprises the real-time brushing position of the brush head. The range determination module 1020 is further configured to determine the target tooth surface where the brush head is currently located according to the real-time brushing position of the brush head. The range determination module 1020 is further configured to determine the target motion range corresponding to the target tooth surface.

In one optional embodiment, the target tooth surface is any one of the occlusal surface, the outer side surface and the inner side surface of the teeth. The occlusal surface of the teeth refers to the surface of the teeth configured for biting. The outer side surface of the teeth refers to the surface of the teeth close to the lips. The inner side surface of the teeth refers to the surface of the teeth close to the tongue. The target motion range corresponding to the occlusal surface of the teeth is not greater than the target motion range corresponding to the inner side surface of the teeth, and the target motion range corresponding to the inner side surface of the teeth is less than the target motion range corresponding to the outer side surface of the teeth.

In one optional embodiment, when the toothbrush is determined to be in the non-tooth-surface area according to the real-time brushing position, the range determination module 1020 is configured to determine the target motion range corresponding to the non-tooth-surface area. The target motion range corresponding to the non-tooth-surface area is not greater than the target motion range corresponding to the tooth surface.

In one optional embodiment, the oral health data comprises the oral health data respectively corresponding to different oral areas. The real-time brushing data comprises the real-time brushing position of the brush head in the working state. The target motion range corresponding to the rotor of the motor of the toothbrush is determined according to the oral health data and the real-time brushing data.

The range determination module 1020 is configured to determine the target oral area where the toothbrush is currently located according to the real-time brushing position. The range determination module 1020 is further configured to determine the target motion range corresponding to the rotor of the motor according to the oral health data corresponding to the target oral area.

In one optional embodiment, the range determination module 1020 is configured to determine the target motion range corresponding to the rotor of the motor according to the oral health data.

The control module 1030 is configured to control the rotor 130 to reciprocate in the circumferential direction within the target motion range.

The range determination module 1020 is configured to adjust the target motion range according to the real-time brushing data of the toothbrush. The control module 1030 is configured to control the rotor 130 to reciprocate in the circumferential direction within the adjusted target motion range to drive the brush head to brush the teeth.

In one optional embodiment, the control device 1000 of the toothbrush 100 further comprises a historical data acquisition module and a storage module.

In one optional embodiment, the historical data acquisition module is configured to obtain the at least one historical experience data. The at least one historical experience data comprises the historical motion range, the historical oral health data and/or the historical real-time brushing data corresponding to the historical motion range, and the experience satisfaction degree corresponding to the historical motion range.

The range determination module 1020 is configured to determine the initial motion range corresponding to the rotor of the motor according to the oral health data and/or the real-time brushing data. The range determination module 1020 is further configured to adjust the initial motion range corresponding to the rotor according to the at least one historical experience data to determine the target motion range corresponding to the rotor.

When the toothbrush completes the brushing process, the storage module is configured to collect the corresponding experience satisfaction degree during the brushing process. The storage module is further configured to store the oral health data and/or the real-time brushing data, the target motion range, and a collected experience satisfaction degree as the latest historical experience data.

In one optional embodiment, the control module 1030 is configured to control the rotor 130 to swing in the reciprocating manner with the reference position as the reference zero axis according to the target motion range, and the control module 1030 is further configured to control the rotor to rotate within the target motion range to change the reference position.

In one optional embodiment, the control device 1000 of the toothbrush 100 further comprises a parameter determination module.

The parameter determination module is configured to determine the swing parameters of the rotor.

In one optional embodiment, the real-time brushing data comprises the real-time brushing position where the brush head is located in the working state.

The parameter determination module is configured to determine the target tooth surface where the brush head is currently located according to the real-time brushing position of the brush head. The parameter determination module is further configured to determine the swing frequency corresponding to the target tooth surface.

The target tooth surface is any one of the occlusal surface, the outer side surface and the inner side surface of the teeth. The occlusal surface of the teeth refers to the surface of the teeth configured for biting. The outer side surface of the teeth refers to the surface of the teeth close to the lips. The inner side surface of the teeth refers to the surface of the teeth close to the tongue. The swing frequency corresponding to the occlusal surface of the teeth is greater than the swing frequency corresponding to the outer side surface of the teeth. The swing frequency corresponding to the occlusal surface of the teeth is greater than the swing frequency corresponding to the inner side surface of the teeth.

In one optional embodiment, when the brush head is determined to be located on the occlusal surface of the teeth according to the real-time brushing position, the control module 1030 controls the rotor 130 to swing in the reciprocating manner with the reference position as the reference zero axis based on the swing parameters corresponding to the occlusal surface of the teeth, and the control module 1030 keeps the reference position unchanged.

In one embodiment, the control device 1000 of the toothbrush 100 further comprises a limit module, a position detection module and a reset module.

The limit module is configured to determine the position limit range corresponding to the target motion range corresponding to the rotor. The position limit range is not less than the target motion range corresponding to the rotor.

The position detection module is configured to determine the current position of the rotor 130 through the position sensor.

When the current position of the rotor is not within the position limit range, the reset module controls the rotor 130 to reset to be within the position limit range.

In one embodiment, the toothbrush 100 further comprises a detection device. The detection device comprises one or more of a posture sensor, a camera, a motion sensor, a pressure sensor, and a photoelectric sensor.

The data acquisition module 1010 is further configured to obtain real-time brushing data through the detection device when the toothbrush 100 is in the working state.

In the embodiment of the present disclosure, the toothbrush 100 obtains the oral health data and/or the real-time brushing data, determines the target motion range corresponding to the rotor 130 of the motor 20 according to the oral health data and/or the real-time brushing data, and controls the rotor 130 to reciprocate in the circumferential direction within the target motion range to drive the brush head to brush the teeth. The toothbrush 100 determines the target motion range of the rotor 130 of the motor 20 according to the oral health data and/or the real-time brushing data, and adaptively adjusts the target motion range of the rotor 130 of the motor 20 so that the determined target motion range is more in line with the actual situation of the oral cavity of the user, thereby flexibly adjusting the maximum rotation angle of the brush head. Therefore, the toothbrush 100 effectively prevents the brush head from hitting the teeth during the use of the toothbrush, ensures the oral health of the user, and improves the use experience of the user.

FIG. 11 is a block diagram of the toothbrush according to one embodiment of the present disclosure. As shown in FIG. 11, the toothbrush 100 comprises at least one processor 1110 and at least one memory 1120 coupled to the at least one processor 1110. The memory 1120 may store one or more computer programs. When executed by the at least one processors 1110. the one or more computer programs are configured to implement the control method described in the above embodiments

The at least one processor 1110 comprises one or more processing cores. The at least one processor 1110 is connected to various parts of the toothbrush 100 through various interfaces and lines. The at least one processor 1110 executes various functions and processes data of the toothbrush 1100 by running or executing instructions, programs, code sets, or instruction sets stored in the at least one memory 1120, and calling data stored in the at least one memory 1120. Optionally, the at least one processor 1110 is implemented in at least one hardware form of a digital signal processing (DSP), a field programmable gate array (FPGA), and a programmable logic array (PLA). The at least one processor 1110 may integrate one or more combinations of a central processing unit (CPU), a graphics processing unit (GPU), and a modem. The CPU mainly processes an operating system, a user interface, and application programs. The GPU is responsible for rendering and drawing display content. The modem is configured to process wireless communications. It is understood that the above-mentioned modem may not be integrated into the at least one processor 1110, and it is allowed to be implemented separately through a communication chip.

The at least one memory 1120 comprises a random access memory (RAM) or a read-only memory (ROM). The at least one memory 1120 is configured to store instructions, programs, codes, code sets, or instruction sets. The at least one memory 1120 comprises a program storage area and a data storage area. The program storage area is configured to store instructions for implementing the operating system, instructions for implementing at least one function (such as a touch function, a sound playback function, an image playback function, etc.), instructions for implementing the above-mentioned control method of the embodiments, etc. The data storage area is configured to store data created by the toothbrush 1100 during use.

It is understandable that the toothbrush 1100 comprises more or fewer structural elements than that shown in FIG. 11. For example, the toothbrush 1100 comprises a display device, a power module, physical buttons, a WIFI module, a speaker, a BLUETOOTH module, a sensor, etc., which are not limited thereto.

The embodiments of the present disclosure provide a computer-readable storage medium storing the computer programs. When executed by the at least one processor, the computer programs implement the control method described in the above embodiments.

The embodiments of the present disclosure provide a computer program product. The computer r program product comprises a non-transitory computer-readable storage medium storing the computer programs. When executed by the at least one processor, the computer programs implement the control method described in the above embodiments.

Those skilled in the art can understand that all or part of the processes in the above-mentioned embodiments may be implemented by instructing related hardware through the computer programs, and the computer programs may be stored in a non-volatile computer-readable storage medium. When the computer programs are executed, it comprises the processes of the control methods of the above-mentioned embodiments. The computer-readable storage medium may be a disk, an optical disk, a ROM, etc.

Any reference to memory, storage, database, or other medium may include nonvolatile and/or volatile memory. Suitable nonvolatile memory may comprise the ROM, a programmable ROM (PROM), an erasable PROM (EPROM), an electrically erasable PROM (EEPROM), or flash memory. The volatile memory comprises a random access memory (RAM), which is served as an external cache memory. As an illustration and not limitation, the RAM may be in various forms, such as a static RAM (SRAM), a dynamic RAM (DRAM), a synchronous DRAM (SDRAM), a double data rate SDRAM (DDR SDRAM), an enhanced SDRAM (ESDRAM), a synchronous link DRAM (SLDRAM), a Rambus DRAM (RDRAM), and direct rambus DRAM (DRDRAM).

The above embodiments of the present disclosure provide a detailed illustration to the control method of the toothbrush, the toothbrush, the control device, and the computer readable storage medium. In the present disclosure, specific embodiments are applied to illustrate the principles and implementations of the present disclosure. The above description of the embodiments is only used to better understand methods and core ideas of the present disclosure. Meanwhile, according to the ideas of the present disclosure, changes are made in the specific implementations and the application scope by those skilled in the art. Therefore, the contents of the specification should not be regarded as a limitation of the present disclosure.

What is claimed is:

1. A control method of a toothbrush, comprising:
obtaining oral health data and/or real-time brushing data;
determining a target motion range corresponding to a rotor of a motor of the toothbrush according to the oral health data and/or the real-time brushing data; and
controlling the rotor to reciprocate in a circumferential direction within the target motion range to drive a brush head of the toothbrush to brush teeth;
wherein the toothbrush comprises the brush head, the motor, and a handle, the motor is disposed in the handle.

2. The control method according to claim 1, wherein the oral health data comprises one or more of a gum health level, dental caries information, dental plaque residue, and oral disease information.

3. The control method according to claim 2, wherein when the target motion range corresponding to the rotor is determined according to the oral health data, the step of determining the target motion range corresponding to the rotor of the motor of the toothbrush according to the oral health data comprises:
determining a selected sensitivity level and/or a selected cleaning level according to the oral health data; and
determining the target motion range corresponding to the rotor of the motor according to the selected sensitivity level and/or the selected cleaning level;
wherein the target motion range corresponding to the rotor is in a negative correlation with the selected sensitivity level, and the target motion range corresponding to the rotor is in a positive correlation with the selected cleaning level.

4. The control method according to claim 1, wherein the real-time brushing data comprises one or more of a real-time brushing position of the brush head, a real-time brushing pressure, a real-time brushing mode, and a real-time motion state, when the toothbrush is in a working state.

5. The control method according to claim 4, wherein the target motion range corresponding to the rotor of the motor of the toothbrush is determined according to the oral health data, and a step of determining the target motion range corresponding to the rotor of the motor of the toothbrush according to the oral health data comprises:
when the brush head is detected to shift from a current oral area to another oral area according to the real-time brushing data, determining the target motion range corresponding to the rotor of the motor during a shifting process;
wherein during the shifting process, the target motion range corresponding to the rotor of the motor is less than the target motion range corresponding to the rotor of the motor when the brush head is in any one of oral areas.

6. The control method according to claim 4, wherein the real-time brushing data comprises the real-time brushing position of the brush head, when the target motion range corresponding to the rotor of the motor of the toothbrush is determined according to the oral health data, the step of determining the target motion range corresponding to the rotor of the motor of the toothbrush according to the oral health data comprises:
determining a target tooth surface where the brush head is currently located according to the real-time brushing position of the brush head; and
determining the target motion range corresponding to the target tooth surface.

7. The control method according to claim 1, wherein the target tooth surface is any one of an occlusal surface, an outer side surface and an inner side surface of the teeth, the occlusal surface of the teeth refers to a surface of the teeth configured for biting, the outer side surface of the teeth refers to a surface of the teeth close to lips, and the inner side surface of the teeth refers to a surface of the teeth close to a tongue;
wherein the target motion range corresponding to the occlusal surface of the teeth is not greater than the target motion range corresponding to the inner side surface of the teeth, and the target motion range corresponding to the inner side surface of the teeth is less than the target motion range corresponding to the outer side surface of the teeth.

8. The control method according to claim 4, wherein when the target motion range corresponding to the rotor of the motor of the toothbrush is determined according to the oral health data, the step of determining the target motion range corresponding to the rotor of the motor of the toothbrush according to the oral health data comprises:
when the toothbrush is determined to be in a non-tooth-surface area according to the real-time brushing position, determining a target motion range corresponding to the non-tooth-surface area; and the target motion range corresponding to the non-tooth-surface area is not greater than a target motion range corresponding to a target tooth surface.

9. The control method according to claim 4, wherein the oral health data comprises oral health data respectively corresponding to different oral areas, and the real-time brushing data comprises the real-time brushing position of the brush head in the working state;
wherein when the target motion range corresponding to the rotor of the motor of the toothbrush is determined according to the oral health data and the real-time brushing data, the step of determining the target motion range corresponding to the rotor of the motor of the toothbrush according to the oral health data and the real-time brushing data comprises:
determining a target oral area where the toothbrush is currently located according to the real-time brushing position; and
determining the target motion range corresponding to the rotor of the motor according to the oral health data corresponding to the target oral area.

10. The control method according to claim 1, wherein the control method further comprises steps:
determining the target motion range corresponding to the rotor of the motor according to the oral health data;
controlling the rotor to reciprocate in the circumferential direction within the target motion range; and
adjusting the target motion range according to the real-time brushing data of the toothbrush, and controlling the rotor to reciprocate in the circumferential direction within an adjusted target motion range to drive the brush head to brush the teeth.

11. The control method according to claim 1, wherein before the step of determining the target motion range corresponding to the rotor of the motor of the toothbrush according to the oral health data and/or the real-time brushing data, the control method comprises steps:
obtaining at least one historical experience data, wherein the at least one historical experience data comprises a historical motion range, historical oral health data and/or historical real-time brushing data corresponding to the historical motion range, and an experience satisfaction degree corresponding to the historical motion range;
wherein the step of determining the target motion range corresponding to the rotor of the motor of the toothbrush according to the oral health data and/or the real-time brushing data comprises:
determining an initial motion range corresponding to the rotor of the motor according to the oral health data and/or the real-time brushing data; and
adjusting the initial motion range corresponding to the rotor according to the at least one historical experience data to determine the target motion range corresponding to the rotor.

12. The control method according to claim 11, wherein after the step of controlling the rotor to reciprocate in the circumferential direction within the target motion range to drive the brush head of the toothbrush to brush the teeth, the control method further comprises:
when the toothbrush completes a brushing process, collecting a corresponding experience satisfaction degree during the brushing process;
storing the oral health data and/or the real-time brushing data, the target motion range, and a collected experience satisfaction degree as latest historical experience data.

13. The control method according to claim 1, wherein the step of controlling the rotor to reciprocate in the circumferential direction within the target motion range to drive the brush head of the toothbrush to brush the teeth comprises:
controlling the rotor to swing in a reciprocating manner with a reference position as a reference zero axis according to the target motion range, and controlling the rotor to rotate within the target motion range to change the reference position.

14. The control method according to claim 13, wherein the steps of determining the target motion range corresponding to the rotor of the motor of the toothbrush according to the oral health data and/or the real-time brushing data and controlling the rotor to reciprocate in the circumferential direction within the target motion range to drive the brush head of the toothbrush to brush the teeth comprise:
determining swing parameters of the rotor, rotation parameters of the rotor, and the target motion range corresponding to the rotor of the motor according to the oral health data and/or the real-time brushing data; and
controlling the rotor to swing in the reciprocating manner with the reference position as the reference zero axis based on the swing parameters according to the target motion range corresponding to the rotor, and controlling the rotor to rotate within the target motion range based on the rotation parameters to change the reference position.

15. The control method according to claim 14, wherein the real-time brushing data comprises a real-time brushing position where the brush head is located in a working state, and the swing parameters comprise a swing frequency of the rotor and a swing amplitude of the rotor;
wherein when the target motion range corresponding to the rotor of the motor of the toothbrush is determined according to the oral health data; the step of determining the target motion range corresponding to the rotor of the motor of the toothbrush according to the oral health data comprises:
determining a target tooth surface where the brush head is currently located according to the real-time brushing position of the brush head; and determining at least one of the swing parameters and the rotation parameters corresponding to the target tooth surface; and
determining a target tooth area where the brush head is currently located according to the real-time brushing position, and determining at least one of a swing frequency and a swing amplitude corresponding to the target tooth area.

16. The control method according to claim 15, wherein the target tooth surface is one of an occlusal surface, an outer side surface and an inner side surface of the teeth, a swing frequency corresponding to the occlusal surface of the teeth is greater than a swing frequency corresponding to the outer side surface of the teeth, and the swing frequency corresponding to the occlusal surface of the teeth is greater than a swing frequency corresponding to the inner side surface of the teeth, and/or
a swing amplitude corresponding to the occlusal surface of the teeth is less than a swing amplitude corresponding to the outer side surface of the teeth, and the swing amplitude corresponding to the occlusal surface of the teeth is greater than a swing amplitude corresponding to the inner side surface of the teeth.

17. The control method according to claim 15, wherein the control method further comprises:
when the brush head is determined to be located on the occlusal surface of the teeth according to the real-time brushing position, controlling the rotor to swing in the reciprocating manner with the reference position as the reference zero axis based on the swing parameters corresponding to the occlusal surface of the teeth, and keeping the reference position unchanged.

18. The control method according to claim 1, wherein the motor further includes a position sensor, and after the step of controlling the rotor to reciprocate in the circumferential direction within the target motion range to drive the brush head of the toothbrush to brush the teeth, the control method further comprises:
determining a position limit range corresponding to the target motion range corresponding to the rotor, wherein the position limit range is not less than the target motion range corresponding to the rotor;
determining a current position of the rotor through the position sensor; and
when the current position of the rotor is not within the position limit range, controlling the rotor to reset to be within the position limit range.

19. The control method according to claim 1, wherein the toothbrush further comprises a detection device, the detection device comprises one or more of an attitude sensor, a camera, a motion sensor, a pressure sensor, and a photoelectric sensor;
wherein the step of obtaining the real-time brushing data comprises:
obtaining the real-time brushing data through the detection device when the toothbrush is in a working state.

20. A toothbrush, comprising:
a motor;
a brush head;
a memory; and
a processor;
wherein computer programs are stored in the memory, when the computer programs are executed by the processor, the processor is configured to execute steps:
obtaining oral health data and/or real-time brushing data;
determining a target motion range corresponding to a rotor of the motor according to the oral health data and/or the real-time brushing data; and
controlling the rotor to reciprocate in a circumferential direction within the target motion range to drive the brush head to brush teeth.
